(19) United States
(12) Patent Application Publication
(10) Pub. No.: US 2002/0019175 A1
(43) Pub. Date: Feb. 14, 2002

(54) Connector device and connection element

(76) Inventors: Masaharu Higuchi, Tokyo (JP); Nobuyuki Yasuda, Chiba (JP)

Correspondence Address: JAY H. MAIOLI, Cooper & Dunham LLP, 1185 Avenue of the Americas, New York, NY, 10036, US

(21) Appl. No.: 09/793,200

(22) Filed: Feb. 26, 2001

(30) Foreign Application Priority Data
Feb. 28, 2000 (JP) P2000-055990
Jan. 29, 2001 (JP) P2001-019776

(51) Int. Cl. H01R 11/00

(52) U.S. Cl. 439/680

(57) ABSTRACT

Disclosed is a connector including a plug jointed to an end of a signal cable and a jack, which is capable of preventing, when the signal cable is pulled in a state that the plug is connected to the jack, the plug from being removed from the jack by the locking between locking claws provided on the jack and locking claw receiving portions provided in the plug, and which is capable of releasing the above locking by sliding a housing provided on the plug, thereby easily removing the plug from the jack.

### BACKGROUND OF THE INVENTION

The present invention relates to a connector device including a plug jointed at its end to a signal cable and a jack to be connected to the plug, which is capable of preventing the removal of the plug from the jack when the signal cable is pulled, and which is capable of easily removing the plug from the jack by sliding a housing provided on a main body of the plug.

Conventionally, exclusive signal cables have been used for connecting a plurality of electronic equipment to each other, and connectors are used for connecting the signal cables to the electronic equipment. For example, a signal cable is generally connected to electronic equipment by inserting a plug or a jack mounted to an end of the signal cable to a jack or a plug provided on the equipment side.

In recent years, as signal cables used for connecting various kinds of electronic equipment to each other, there have been used not only conventional well-known electric signal cables but also optical signal cables for transmitting information by making use of light.

By the way, a connector provided on the electronic equipment side is often disposed at an inconspicuous position, for example, on the back side of the electronic equipment, from the viewpoint of the external appearance of the electronic equipment. Accordingly, it is desired that a plug or a jack be easily inserted or removed in or from a jack or a plug.

On the other hand, along with the spread of information equipment, a plurality of electronic equipment have been used in a state being connected to each other via a number of signal cables. In this case, if the connection of one of the signal cables is removed for some reason, it becomes difficult to detect the removed signal cable. Accordingly, a connection portion between a plug and a jack has been required to have a structure not removed even if a relatively large tension is applied to the signal cable.

### SUMMARY OF THE INVENTION

An object of the present invention is to provide a connector device including a connecting portion jointed to an end of a signal cable and a portion to be connected to the connecting portion, which is capable of preventing the removal of the connecting portion when a signal cable is pulled, and which is capable of easily removing the connecting portion from the portion to be connected by sliding a housing of the connecting portion.

To achieve the above object, according to a first aspect of the present invention, there is provided a connector device including a connecting portion jointed to an end of a signal cable, and a portion to be connected, in or out of which the connecting portion is insertable and removable. The portion to be connected includes locking means for locking the connecting portion, and lock releasing means for releasing the locking of the connecting portion by the locking means. The connecting portion includes connecting main body means to which the signal cable is jointed. The connecting main body includes a fitting portion in which the locking means of the portion to be connected is fitted for preventing the portion to be connected from being removed from the connecting portion when the signal cable is pulled. The connecting portion also includes housing means provided on the outer peripheral side of the connecting main body means in such a manner as to cover at least part of the connecting main body means and to be movable in parallel to the projecting direction of the connecting main body means. The locking of the connecting portion by the locking means is released by a motion of the lock releasing means of the portion to be connected along with the movement of the housing means.

According to a second aspect of the present invention, there is provided a connection element to which a signal cable is jointed and which is to be connected to a counter element. The counter element includes removal preventive means for preventing, after the connection element is connected to the counter element, the connection element from being removed therefrom. The connection element includes plug main body means connected to an end of the signal cable; housing means provided on the outer peripheral side of the plug main body means in such a manner as to cover at least part of the plug main body means and to be movable in parallel to the projecting direction of the plug main body; locking means which is fitted with the removal preventive means of the counter element when the connection element is connected to the counter element, thereby preventing the plug main body means from being removed from the counter element when the signal cable is pulled; and lock releasing means for releasing, when the housing means is moved in the removal direction of the connection element from the counter element, the locking between the counter element and the plug main body means by the fitting of the locking means with the removal preventive means of the counter element.

According to a third aspect of the present invention, there is provided a connection element to which a connecting plug is insertable and removable. The connecting plug has a connecting main body jointed to an end of a signal cable, and a housing provided on the outer peripheral side of the connecting main body in such a manner as to cover at least part of the connecting main body and to be movable in parallel to the projecting direction of the connecting main body. The connection element includes locking means for locking the removal of the connecting plug when the signal cable is pulled; and lock releasing means for releasing, when the housing of the connecting plug is moved in a specific direction, the locking of the connecting plug by the locking means.

### BRIEF DESCRIPTION OF THE DRAWINGS

FIG. 1 is a view showing a usage pattern of a connector according an embodiment of the present invention;

FIG. 2A is a perspective view illustrating a structure of a plug side of the connector according to the embodiment of the present invention;

FIG. 2B is a sectional view illustrating a structure of the plug side, which is in a state being inserted in a jack side, of the connector according to the embodiment of the present invention;

FIG. 2C is a sectional view illustrating a structure of the plug side, which is in a state being pulled out of the jack side, of the connector according to the embodiment of the present invention;

FIG. 3 is an exploded perspective view illustrating a configuration of the jack side of the connector according to the embodiment of the present invention;

FIG. 4A is a perspective view illustrating the configuration of the jack side of the connector according to the embodiment of the present invention;

FIG. 4B is a view seen from the plug insertion side illustrating the configuration of the jack side of the connector according to the embodiment of the present invention;

FIG. 4C is a sectional view illustrating the configuration of the jack side of the connector according to the embodiment of the present invention;

FIG. 5A is a view illustrating an action of pulling the plug from the jack, more specifically, showing a state that the plug is being locked in the jack, in the connector according the embodiment of the present invention;

FIG. 5B is a view illustrating the action of pulling the plug from the jack, more specifically, showing a state that the locking of the plug is released, in the connector according the embodiment of the present invention;

FIG. 5C is a view illustrating the action of pulling the plug from the jack, more specifically, showing a state that the plug is started to be pulled out of the jack, in the connector according the embodiment of the present invention;

FIG. 5D is a view illustrating the action of pulling the plug from the jack, more specifically, showing a state that lock claws reach a taper portion of the plug, in the connector according the embodiment of the present invention;

FIG. 6A is a view illustrating an action of inserting the plug in the jack, more specifically, showing a state before the lock claws are opened, in the connector according the embodiment of the present invention;

FIG. 6B is a view illustrating the action of inserting the plug in the jack, more specifically, showing a state that the lock claws are started to be opened, in the connector according the embodiment of the present invention;

FIG. 6C is a view illustrating the action of inserting the plug in the jack, more specifically, showing a state that the lock claws are fitted in lock claw receiving portion, in the connector according the embodiment of the present invention;

FIG. 7A is a sectional view illustrating another configuration of the plug side, more specifically, showing a state that a housing is located at a locking position, in the connector according to the embodiment of the present invention;

FIG. 7B is a sectional view illustrating the configuration of the plug side shown in FIG. 7A, more specifically, showing a state that the housing is located at a lock releasing position, in the connector according to the embodiment of the present invention; and

FIG. 8 is a sectional view showing another configuration of the jack side of the connector according to the embodiment of the present invention.

### DESCRIPTION OF THE PREFERRED EMBOIDIMENTS

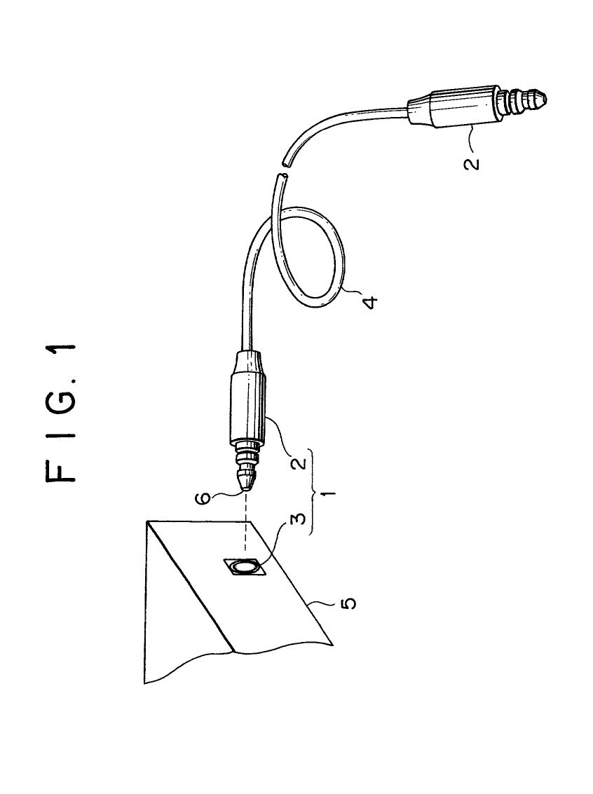

FIG. 1 is a view showing a usage pattern of a connector device according to an embodiment of the present invention.

A connector 1 representative of the connector device according to this embodiment shown in FIG. 1 includes a plug 2 and a jack 3. The plug 2 is mounted to, for example, an end portion of an optical cable 4 for transmitting light signals, and the jack 3 is mounted, for example, to a back side of an electronic equipment 5.

In the connector 1, when the plug 2 is inserted in the jack 3, a cable conductor 6 of the optical cable 4, which is exposed from the tip of the plug 2, is connected to a cable conductor (not shown) or an opening window of an optical transmitter-receiver (not shown) on the electronic equipment 5 side, which is exposed in the jack 3.

In addition, although the optical cable 4, to both ends of which the plugs 2 having the same shape are mounted, is shown in FIG. 1, both the plugs mounted to the optical cable 4 are not necessarily configured to have the same shape. One end of the optical cable 4 may be directly jointed to electronic equipment.

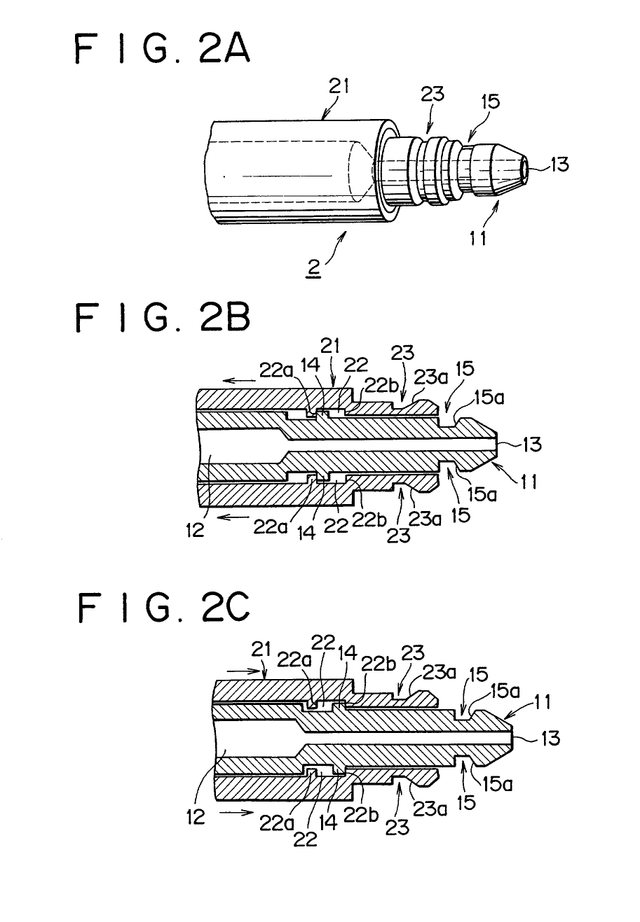

A structure of the connector 1 according to this embodiment will be described below with reference to FIGS. 2A, 2B and 2C, FIG. 3, and FIGS. 4A, 4B and 4C.

First, a structure of the plug 2 will be described with reference to FIGS. 2A, 2B and 2C.

FIGS. 2A, 2B and 2C are views illustrating the structure of the plug 2 in this embodiment, wherein FIG. 2A is a plan view of the plug. 2, and FIGS. 2B and 2C are sectional views of the plug 2.

The plug 2 includes a plug main body 11, and a housing 21 formed on the outer peripheral side of the plug main body 11.

The inside of the plug main body 11 is, as shown in FIGS. 2B and 2C, formed into a hollow shape, and an optical cable covered with a coating is inserted in this hollow portion 12 in a state that a conductor, from which the coating is removed, of the optical cable is exposed from an opening 13 formed in the tip of the plug main body 11.

As shown in FIGS. 2B and 2C, projections 14 are formed on the outer peripheral surface of the plug main body 11 covered with the housing 21, for example, at upper and lower positions thereof; and recesses 22, each having a width wider than a width of the projection 14 in the longitudinal direction of the plug 2, are formed in the inner peripheral surface of the housing 21 at positions corresponding to those of the projections 14.

The housing 21 is thus movable in the horizontal direction within a range from a position (see FIG. 2B) at which the projections 14 are brought into contact with left side surfaces 22a of the recesses 22 to a position (see FIG. 2C) at which the projections 14 are brought into contact with right side surfaces 22b of the recesses 22.

A lock releasing claw receiving portion 23, which constitutes a rock releasing mechanism in cooperation with lock releasing claws on the jack 3 side (which will be described later), is formed into an annular shape in the outer peripheral surface of the tip side of the housing 21. A right wall surface, on the plug main body 11 side, of the lock releasing claw receiving portion 23 is formed into a taper surface 23a.

A lock claw receiving portion 15, which constitutes a lock mechanism in cooperation with lock claws on the jack 3 side (which will be described later), is formed into an annular shape in the outer peripheral surface, not covered with the housing 21, of the tip side of the plug main body 11. A wall surface, on the tip side, of the lock claw receiving portion 15 is formed into a taper surface 15a steeper than the taper 23a of the lock releasing claw receiving portion 23.

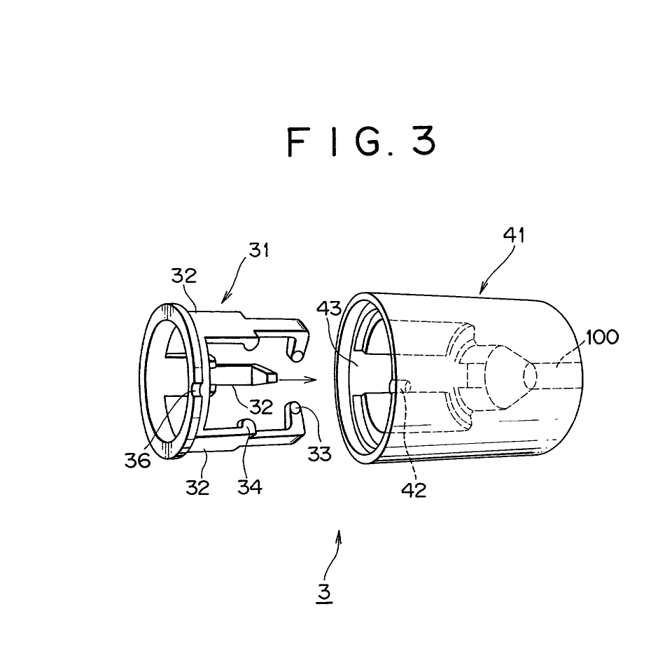

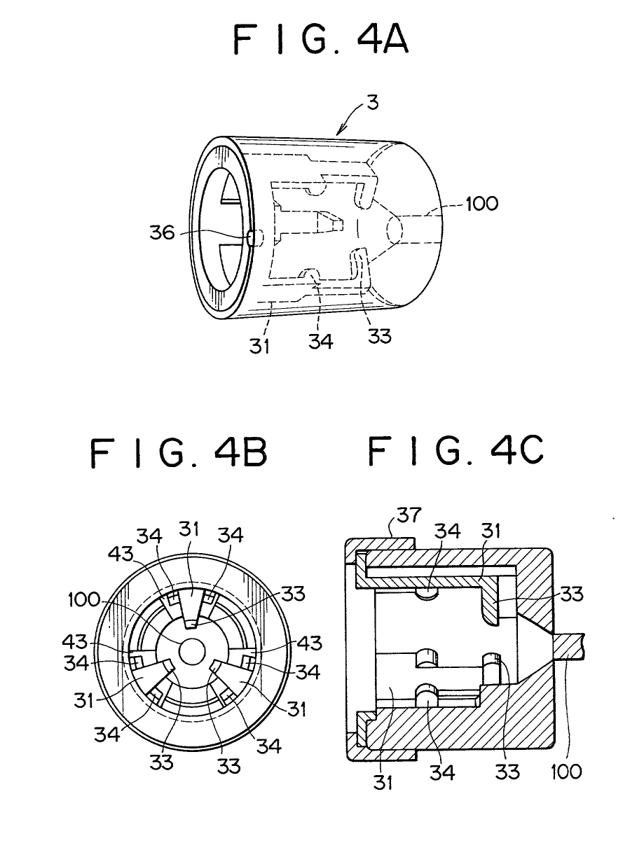

A structure of the jack 3 will be described below with reference to FIG. 3, and FIGS. 4A, 4B and 4C.

FIG. 3 is an exploded perspective view illustrating the structure of the jack 3 in this embodiment, and FIG. 4A, 4B and 4C are a perspective view, a plan view, and a sectional view of the jack 3, respectively.

As shown in FIG. 3, the jack 3 includes a lock unit 31 and a holder 41. The lock unit 31 has three arms 32 having elasticity, which are spaced from each other at equal intervals. It should be noted that the number of the arms 32 is not necessarily set to three but may be set to at least two or more.

A lock claw 33 is formed on the tip of each arm 32 in such a manner as to project inwardly therefrom. The tip of the lock claw 33 is rounded.

A pair of lock releasing claws 34, each of which is configured as a projection rounded in cross-section, are provided, as shown in FIG. 4C, on both sides of the vicinity of the center of the arm 32 having at its tip the lock claw 33.

The lock unit 31 has a positioning groove 36 for positioning the lock unit 31 at the time of assembly of the lock unit 31 with the holder 41. The holder 41 has a positioning projection 42 corresponding to the positioning groove 36. In the case of mounting the lock unit 31 to the holder 41, the positioning projection 42 is fitted in the positioning groove 36, whereby the position of the lock unit 31 to the holder 41 is determined.

Guide grooves 43 for guiding the arms 32 at the time of insertion of the lock unit 31 in the holder 41 are formed in the inner surface of the holder 41. The lock unit 31 is inserted in the holder 41 along the guide grooves 43. Although only one guide groove 43 is shown in FIG. 3, the guide groove 43 is actually provided for each arm 32 as shown in FIG. 4B. Since the plug 2 is inserted from an opening of the holder 41, the bottom surface side of the holder 41 is formed into a shape corresponding to the shape of the tip of the plug 2. A conductor 100 of an optical cable led from a circuit board or the like of electronic equipment is disposed at the center position of the holder 41.

In assembling the lock unit 31 in the holder 41, the lock unit 31 can be fixed to the holder 41 in accordance with various manners. One of the manners is to fix the lock unit 31 to the holder 41 with a flange 37 as shown in FIG. 4C.

The material of each of the lock unit 31 and the holder 41 is not particularly limited, but at least the arms 32 of the lock unit 31 are required to be made from elastic material. The structure of each of the lock unit 31 and the holder 41 shown in FIG. 3 and FIGS. 4A, 4B and 4C is, as is apparent from the figures, relatively easier to be released from a mold at the time of production of each of the lock unit 31 and the holder 41. From this viewpoint, the use of a plastic material such as nylon as the material of each of the lock unit 31 and the holder 41 is effective for easy production thereof.

If the lock unit 31 is formed of a member not necessarily high in wear resistance, the tip of each lock claw 33 may be considered to be most worn. In this case, a spherical metal member or a roller may be mounted to the tip of the lock claw 34 for preventing the wear thereof.

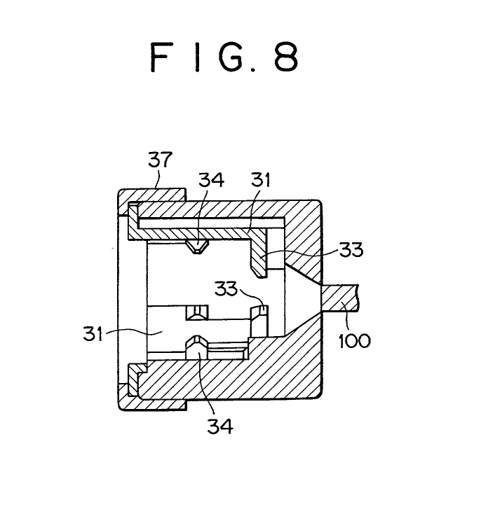

In addition, the lock releasing claw 34 may be configured, as shown by a sectional view of FIG. 8, as a projection formed into an approximately triangular shape in cross-section.

The inserting/pulling action of the connector 1 according to this embodiment will be described below.

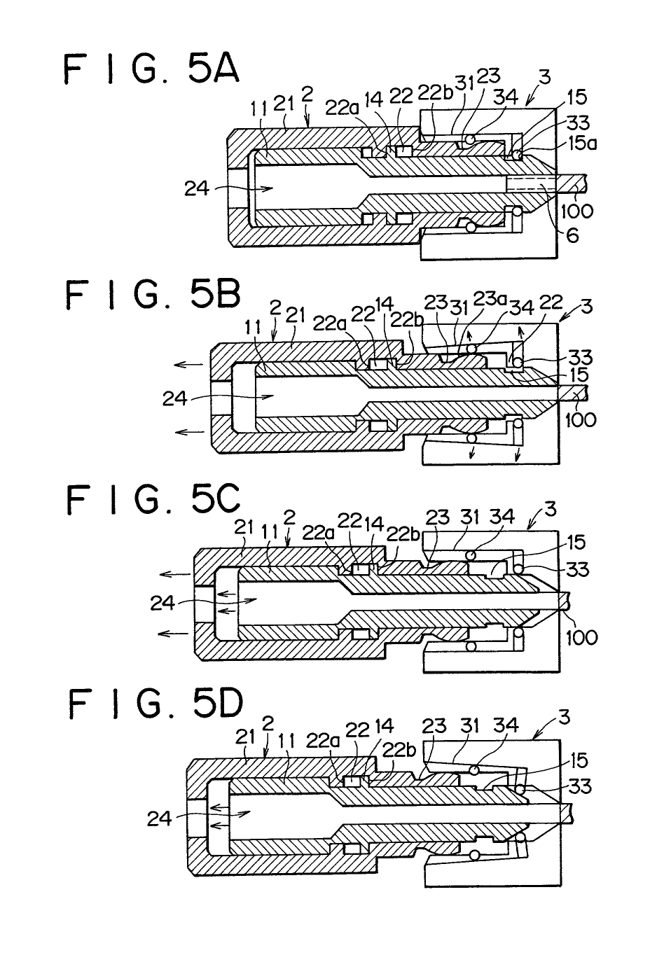

First, the action of pulling the plug 2 out of the jack 3 will be described with reference to FIGS. 5A, 5B, 5C and 5D.

As shown in FIG. 5A, when the plug 2 and the jack 3 are in the connection state, the plug 2 is locked with the jack 3 by the lock mechanism composed of the lock claws 33 and the lock claw receiving portion 15. At this time, the rounded tips of the lock claws 33 are in contact with the taper surface 15a of the lock claw receiving portion 15, so that the conductor 6 of the optical cable 4, exposed from the tip of the plug main body 11, is in contact with the core 100 on the jack 3 side in a state being butted thereto.

At this time, since the position of the housing 21 to the plug main body 11 is fixed by the contact of the projections 14 with the left side walls 22a of the recesses 22 formed in the housing 21, the lock releasing mechanism composed of the lock releasing claws 34 and the lock releasing claw receiving portion 23 is in the engagement state.

When the plug 2 is slid on the left side, that is, in the pulling-out direction by a user for pulling the plug 2 out of the jack 3, the housing 21 of the plug 2 is first slid in the pulling-out direction as shown in FIG. 5B. The lock releasing claws 34 are thus extended outwardly along the taper surface 23a of the lock releasing claw receiving portion 23. As a result, the lock claws 33, formed on the arms 32 on which the lock releasing claws 34 are formed, are moved outwardly, that is, in the lock releasing direction, together with the lock releasing claws 34. At this time, the moved amount of each lock claw 33 in the outward direction, that is, the lock releasing direction becomes larger than the moved amount of the corresponding lock releasing claw 34 in the outward direction because a distance between the fulcrum of the arm 32 to the lock claw 33 is longer than a distance between the fulcrum of the arm 32 to the lock releasing claw 34. In this way, the lock claws 33 are removed from the lock claw receiving portions 15, whereby the locking by the lock mechanism is released.

When the plug 2 is further slid in the pulling-out direction by the user, as shown in FIG. 5C, the projections 14 of the plug main body 11 are brought into contact with the right side surfaces 22b of the recesses 22 of the housing 21, whereby the plug main body 11 is moved in the pulling-out direction together with the housing 21. At this time, the lock claws 33 are located on the outer periphery of the plug main body 11, that is, they are in the state being perfectly released from the lock claw receiving portion 15. After that, as shown in FIG. 5D, as the plug 2 is further slid in the pulling-out direction by the user, the lock claws 33 are moved along the outer periphery of the plug main body 11, and finally the plug 2 is separated from the jack 3.

In this way, according to the connector 1 in this embodiment, in pulling of the plug 2 out of the jack 3, the plug 2 can be removed from the jack 3 by the simple action of sliding the plug 2 in the pulling-out direction.

On the contrary, if the optical cable 4 jointed to the plug 2 is pulled in the pulling-out direction for some reason, the tension is directly applied from the optical cable 4 to the plug main body 11. At this time, since the action described with reference to FIGS. 5A, 5B, 5C and 5D, that is, the action of releasing the lock mechanism by the lock releasing mechanism becomes ineffective, the plug 2 cannot be removed from the jack 3.

However, if the connection between the plug 2 and the jack 3 is kept for a long time in a state that an excess tension is applied to the optical cable 4, there may occur breakage of the optical cable 4 and/or damage of the electronic equipment side to which the optical cable 4 is connected. In this regard, according to the connector 1 in this embodiment, since the tips of the lock claws 33 are rounded and the side wall, on the tip side, of the lock claw receiving portion 15 is taken as the taper surface 15a, if a tension being high enough to cause breakage of the optical cable 4 and damage of the electronic equipment side is applied to the optical cable 4, the lock claws 33 of the lock mechanism are extended along the taper surface 15a, whereby the locking is forcibly released. As a result, even if a tension is applied to the optical cable 4, it is possible to prevent breakage of the optical cable 4 and damage of the electronic equipment side.

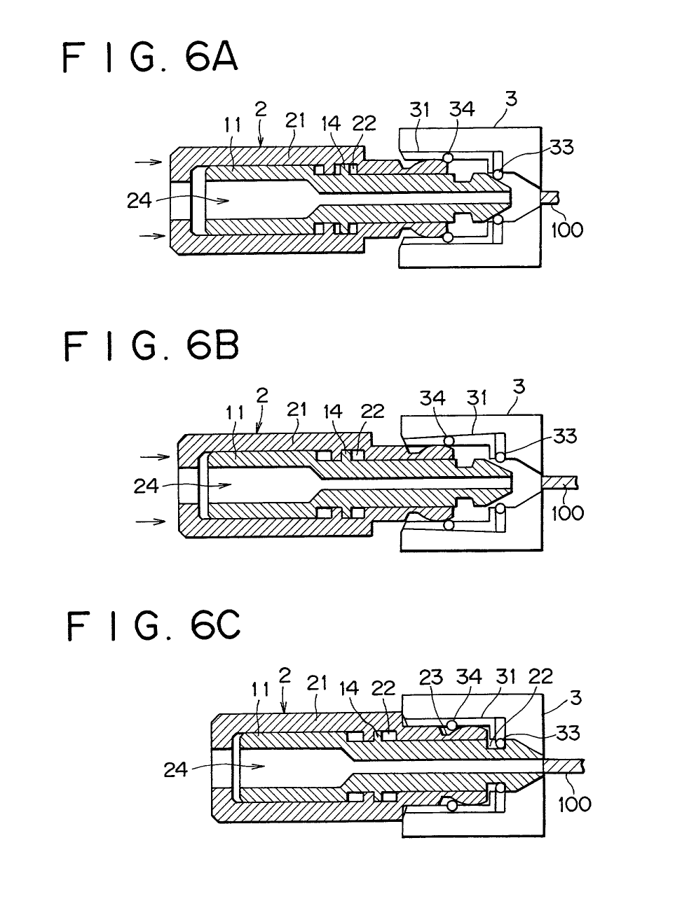

An action of inserting the plug 2 in the jack 3 will be described with reference to FIGS. 6A, 6B and 6C.

First, as shown in FIG. 6A, when the plug 2 is inserted in the jack 3 by a user, the lock claws 33 are moved along the outer periphery of the tip portion of the plug main body 11 and also the lock releasing claws 34 are moved along the outer periphery of the housing 21.

Then, as shown in FIG. 6B, as the plug 2 is further pushed in the insertion direction, the lock claws 33 is moved while being extended outwardly by the plug main body 11, and the lock releasing claws 34 are moved while being extended outwardly by the housing 21.

Finally, as shown in FIG. 6C, when the plug 2 is pushed to a specific position of the jack 3, the lock claws 33 are locked in the lock claw receiving portion 22, and the lock releasing claws 34 are engaged in the lock releasing claw receiving portion 23.

In this way, according to the connector 1 in this embodiment, in the insertion of the plug 2 in the jack 3, the plug 2 can be connected to the jack 3 by the simple action of pushing the plug 2 in the jack 3.

The structure of the plug used for the connector 1 in this embodiment is not limited to the plug 2 shown in FIGS. 2A, 2B and 2C.

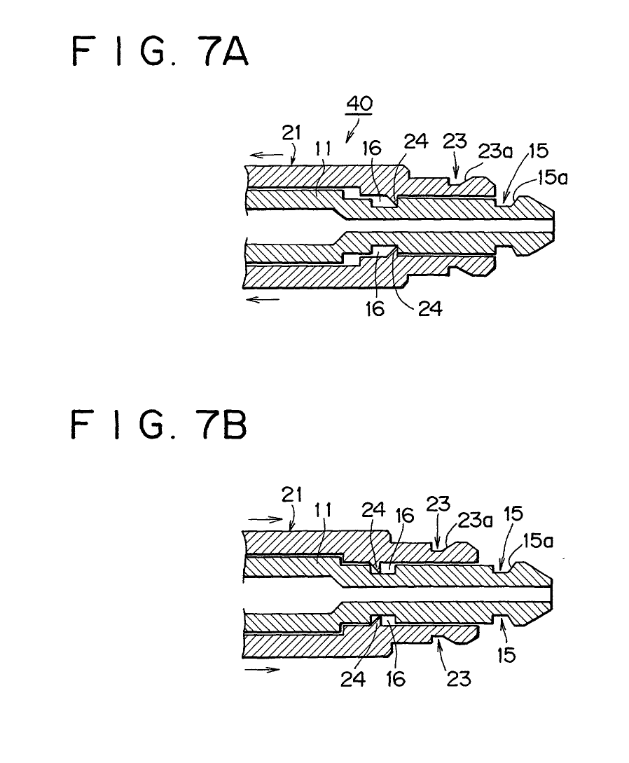

FIGS. 7A and 7B are sectional views showing another plug usable for the connector 1 in this embodiment. In these figures, parts corresponding to those of the plug 2 shown in FIGS. 2A, 2B and 2C are designated by the same reference numerals, and the overlapped description is omitted.

A plug 40 shown in FIGS. 7A, 7B and 7C is configured such that projections 24 are formed on the inner peripheral surface of a housing 21 at upper and lower positions thereof, and recesses 16, each having a width wider than a width of the projection 24 in the longitudinal direction of the plug 40, are formed in the outer peripheral surface of a plug main body 11. With this configuration, the same effect as that obtained in the previous structure can be obtained.

Further, by tapering the projections 24 as shown in FIGS. 7A and 7B, the work of assembling the plug main body 11 in the housing 21 can be easily performed. In addition, the projections 14 shown in FIGS. 2A, 2B and 2C, FIGS. 5A, 5B, 5C and 5D, and FIGS. 6A, 6B and 6C can be also tapered.

Additionally, in the above-described embodiment, the lock claw receiving portion and the lock releasing claw receiving portion are provided on the plug 2 side, and the lock claws 33 and the lock releasing claws 34 are provided on the jack 3 side; however, according to the present invention, the lock claws and the lock releasing claws may be provided on the plug side and the lock claw receiving portion and the lock releasing claw receiving portion be provided on the jack side.

Further, in the above-described embodiment, the present invention has been described by example of the structure of the connector suitable for an optical cable in the above-described embodiment; however, the connector of the present invention can be applied to electrical cables and the like.

As described above, the connector of the present invention includes the locking means for locking the removal of the plug as the connecting portion from the jack as the portion to be connected, and the lock releasing means for releasing the locking means when the housing provided on the plug is moved in the removal direction of the plug from the jack. Accordingly, in the state that the plug is connected to the jack, the plug is locked with the jack, and is prevented from being removed from the jack even if a signal cable is pulled; and in the case of removing the plug from the jack, the locking of the plug with the jack is released by a motion of the lock releasing means along with the sliding motion of the plug in the pulling-out direction, with a result that the plug can be simply removed from the jack.

According to the present invention, the locking mechanism and the lock releasing mechanism can be simply realized by providing the lock releasing claws and the locking claws formed on the same arm on one of the plug and the jack, and providing the engagement groove in which the lock releasing claws are engaged and the locking groove in which the locking claws are locked in the other of the plug and jack.

According to the present invention, since the tips of the locking claws are rounded and the wall surface, on the projecting side, of the locking groove is formed into the inclined surface having a specific inclination, a conductor on the plug side is certainly brought into contact with a conductor or an opening window of an optical device on the jack side in the state that the plug is inserted in the jack, thereby ensuring desirable transmission of signals.

According to the present invention, since the locking of the plug with the jack is released when a tension of a specific value or more is applied to a signal cable, it is possible to prevent breakage of the signal cable and the like.

While the preferred embodiment of the present invention has been described using the specific terms, such description is for illustrative purposes only, and it is to be understood that changes and variations may be made without departing from the spirit or scope of the following claims.

What is claimed is:

1. A connector device including a connecting portion jointed to an end of a signal cable, and a portion to be connected, in or out of which said connecting portion is insertable and removable,
said portion to be connected comprising:
locking means for locking said connecting portion; and
lock releasing means for releasing the locking of said connecting portion by said locking means;
said connecting portion comprising:
connecting main body means to which said signal cable is jointed, said connecting main body means including a fitting portion in which said locking means of said portion to be connected is fitted for preventing said portion to be connected from being removed from said connecting portion when the signal cable is pulled; and
housing means provided on the outer peripheral side of said connecting main body means in such a manner as to cover at least part of said connecting main body means and to be movable in parallel to the projecting direction of said connecting main body means, wherein the locking of said connecting portion by said locking means is released by a motion of said lock releasing means of said portion to be connected along with the movement of said housing means.

2. A connector device according to claim 1, wherein said locking means and said lock releasing means of said portion to be connected are mounted on the same arm means; and
along with the movement of said housing means of said connecting portion, said lock releasing means is moved to release the fitting between said locking means and a fitting portion provided in said connecting main body means of said connecting portion.

3. A connector device according to claim 1, wherein said fitting portion provided in said connecting main body means of said connecting portion is a locking groove provided in the outer peripheral portion of said connecting main body means.

4. A connector device according to claim 1, wherein a portion, to be fitted in said fitting portion, of said locking means of said portion to be connected is formed into a curved surface, and one side surface of said locking groove of said connecting portion is formed into an inclined surface having a specific inclination.

5. A connection element to which a signal cable is jointed and which is to be connected to a counter element, said counter element including removal preventive means for preventing, after said connection element is connected to said counter element, said connection element from being removed therefrom,
said connection element comprising:
plug main body means connected to an end of the signal cable;
housing means provided on the outer peripheral side of said plug main body means in such a manner as to cover at least part of said plug main body means and to be movable in parallel to the projecting direction of said plug main body;
locking means which is fitted with said removal preventive means of said counter element when said connection element is connected to said counter element, thereby preventing said plug main body means from being removed from said counter element when the signal cable is pulled; and
lock releasing means for releasing, when said housing means is moved in the removal direction of said connection element from said counter element, the locking between said counter element and said plug main body means by the fitting of said locking means with said removal preventive means of said counter element.

6. A connection element according to claim 5, wherein said locking means of said connection element is a locking groove provided in the outer peripheral portion of said plug main body means.

7. A connection element to which a connecting plug is insertable and removable, said connecting plug having a connecting main body jointed to an end of a signal cable, and a housing provided on the outer peripheral side of said connecting main body in such a manner as to cover at least part of said connecting main body and to be movable in parallel to the projecting direction of said connecting main body,
said connection element comprising:
locking means for locking the removal of said connecting plug when the signal cable is pulled; and
lock releasing means for releasing, when said housing of said connecting plug is moved in a specific direction, the locking of said connecting plug by said locking means.

8. A connection element according to claim 7, wherein said locking means and said lock releasing means are mounted on the same arm means; and
along with the movement of said housing means of said connecting plug, said lock releasing means is moved to release the fitting between said locking means and a fitting portion provided in said connecting plug.
